(19) United States
(12) Patent Application Publication
(10) Pub. No.: US 2025/0372901 A1
(43) Pub. Date: Dec. 4, 2025

(54) CABLE ASSEMBLY AND CABLE CONNECTOR ASSEMBLY HAVING THE SAME

(71) Applicant: FOXCONN INTERCONNECT TECHNOLOGY LIMITED, Grand Cayman (KY)

(72) Inventors: TING-CUI WANG, Chongqing (CN); YANG-TSUN HSU, New Taipei (TW); CHUN-CHEN LIN, New Taipei (TW); JUN CHEN, Kunshan (CN); WEN-QIANG LAN, Chongqing (CN); YUAN-YUAN LUO, Kuanshan (CN); DAN-NI ZHONG, Kuanshan (CN)

(21) Appl. No.: 19/220,605

(22) Filed: May 28, 2025

(30) Foreign Application Priority Data
May 30, 2024 (CN) 202410684231.2

(51) Int. Cl. H01R 12/75; H01R 12/70; H01R 12/72; H01R 13/02; H01R 13/6591

(52) U.S. Cl. CPC H01R 12/75; H01R 12/7041; H01R 12/707; H01R 12/7088; H01R 12/721; H01R 13/025; H01R 13/6591

(57) ABSTRACT

A cable assembly includes: a cable having plural wires; a wire clamp disposed at a front of the cable; and a shielding sheet fixed to the wire clamp, wherein the plural wires are divided into an upper row and a lower row and fixed to the wire clamp, front ends of the plurality wires extend forward beyond the wire clamp to be directly connected to a mainboard, and the shielding sheet isolates the upper row of wires from the lower row of wires.

### BACKGROUND OF THE INVENTION

### Field of the Invention

The present invention relates generally to a cable assembly and cable connector assembly having the same, and more particularly to a cable assembly that can be directly connected to a mainboard in a device.

### Description of Related Arts

China Patent No. 212162279 discloses an electronic device comprising a device body connected to a connecting cable pluggably connected to the device body, an electrical connector needs to be installed on the device body, and a mating connector that matches the electrical connector needs to be installed on one end of the cable. The signal will be attenuated when passing through the electrical connector and the mating connector, which is not conducive to the transmission of high-speed signals.

An improved cable connector assembly is desired.

### SUMMARY OF THE INVENTION

The objective of the present invention is to provide a cable assembly whose cable can be directly connected to the mainboard in the device, so as to transmit high-speed signals.

To achieve the above object, a cable assembly includes: a cable having a plurality of wires; a wire clamp disposed at a front of the cable; and a shielding sheet fixed to the wire clamp, wherein the plurality of wires are divided into an upper row and a lower row and fixed to the wire clamp, front ends of the plurality wires extend forward beyond the wire clamp to be directly connected to a mainboard, and the shielding sheet isolates the upper row of wires from the lower row of wires.

Compared to prior art, in the present invention, the wires of the cable are directly connected to the mainboard in the device, which can realize higher-speed signal transmission, in addition, the shielding sheet separates the upper row and lower row of wires to reduce crosstalk between the upper and lower rows, which is beneficial to transmission of high-speed signals.

### BRIEF DESCRIPTION OF THE DRAWING

FIG. 1 is a perspective view of a cable connector assembly according to the present being soldered to a mainboard;

FIG. 2 is a perspective view of the cable assembly of the cable connector assembly of FIG. 1, soldered on the mainboard;

FIG. 3 is another perspective view of the cable assembly of FIG. 2, soldered on the mainboard

FIG. 4 is a perspective view of the cable assembly of FIG. 2 after being soldered on the mainboard but before being glued;

FIG. 5 is another perspective view of the cable assembly of FIG. 4, after being soldered on the mainboard but before being glued;

FIG. 6 is a perspective view of the cable assembly of FIG. 4 before being soldered to the mainboard;

FIG. 7 is another perspective view of the cable assembly of FIG. 6 before being soldered to the mainboard;

FIG. 8 is a perspective view of cable assembly of FIG. 6;

FIG. 9 is another perspective view of the cable assembly of FIG. 8;

FIG. 10 is an exploded view of the cable assembly of FIG. 8;

FIG. 11 is another exploded view of the cable assembly of FIG. 10;

FIG. 12 is a perspective view of the wire clamp and shielding sheet of the cable assembly cable assembly of FIG. 10; and

FIG. 13 is another perspective view of the wire clamp and shielding sheet of the cable assembly cable assembly of FIG. 12.

### DETAILED DESCRIPTION OF THE PREFERRED EMBODIMENT

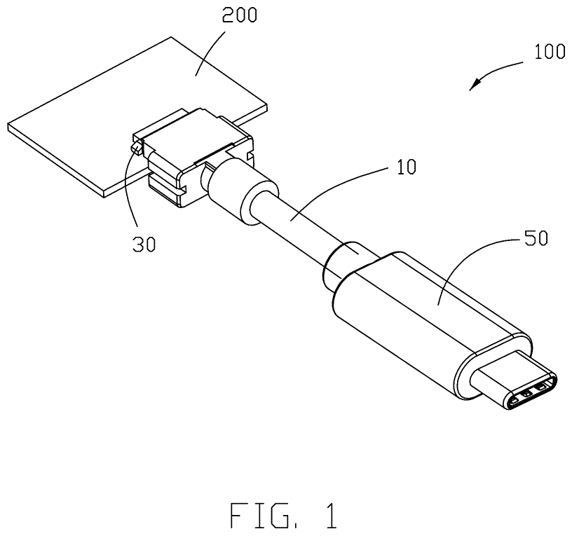

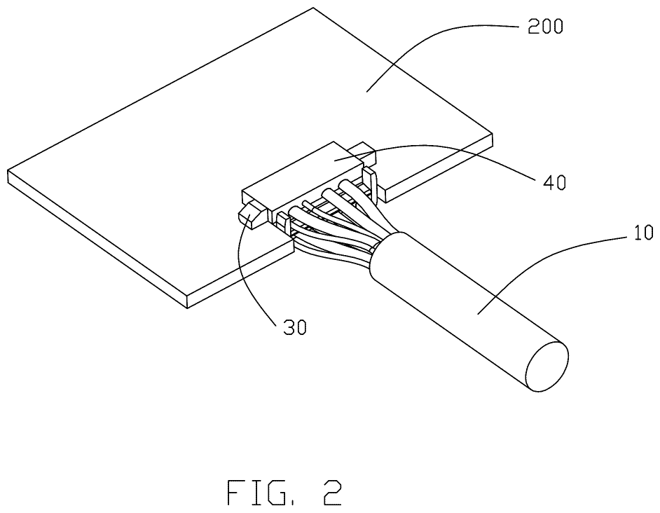

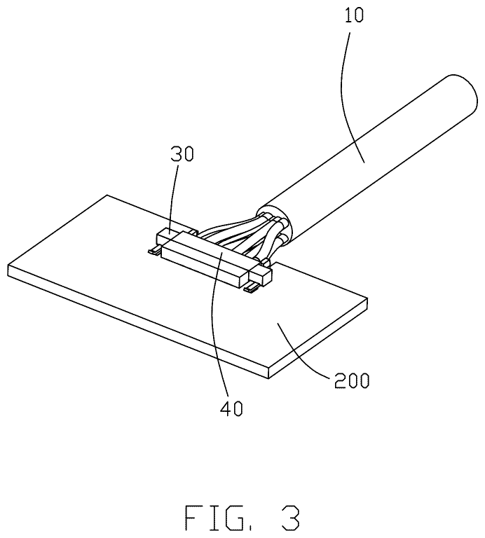

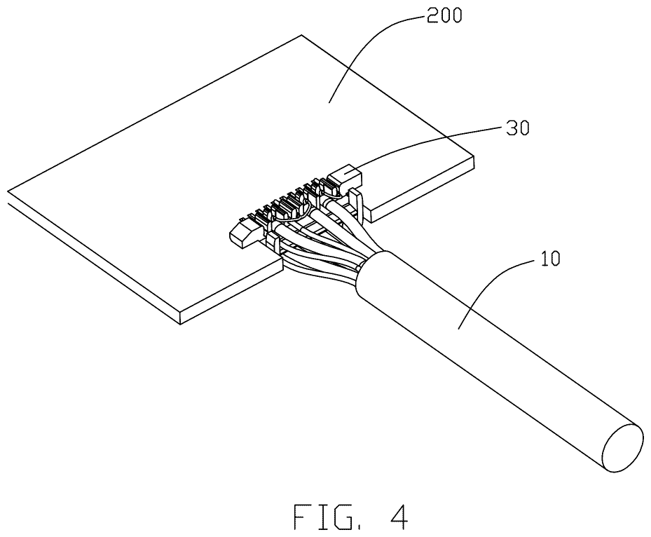

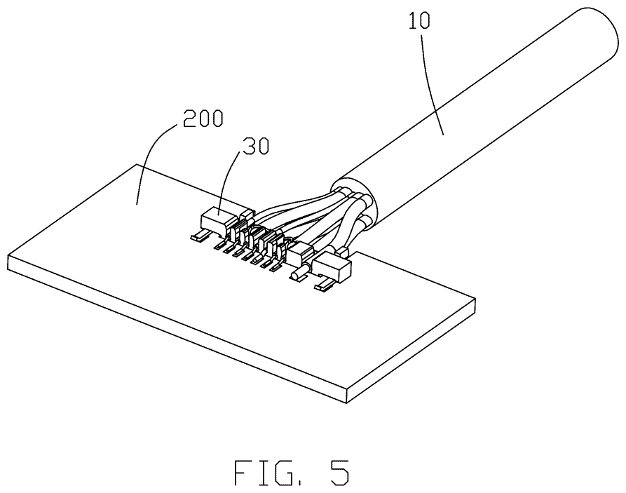

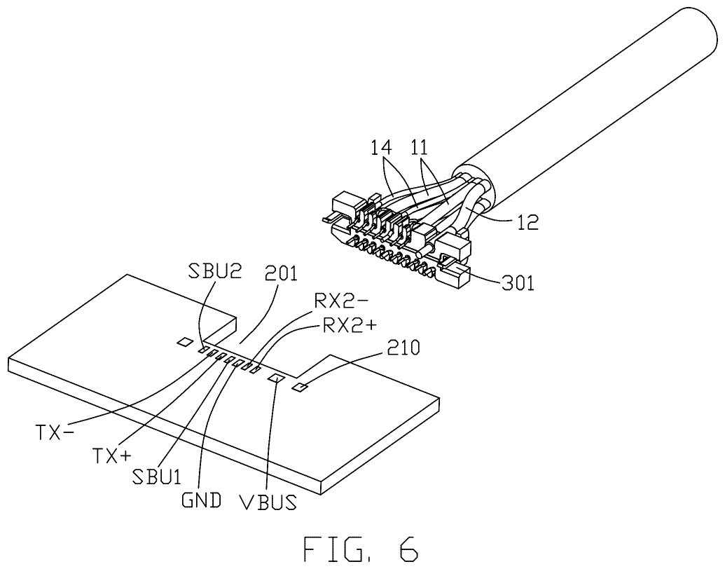

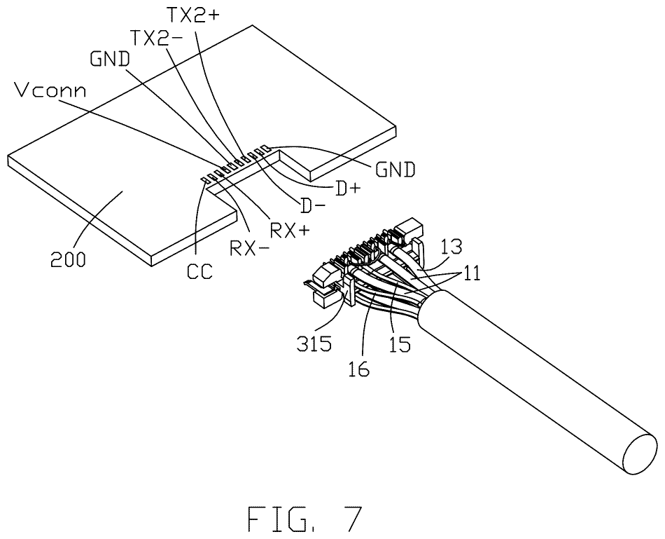

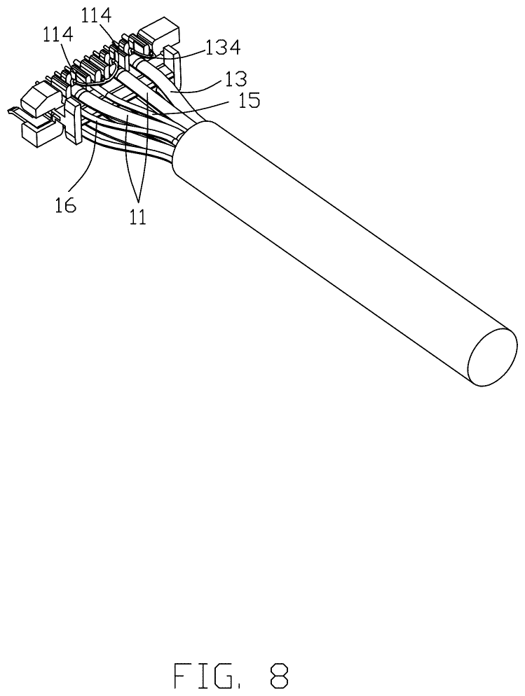

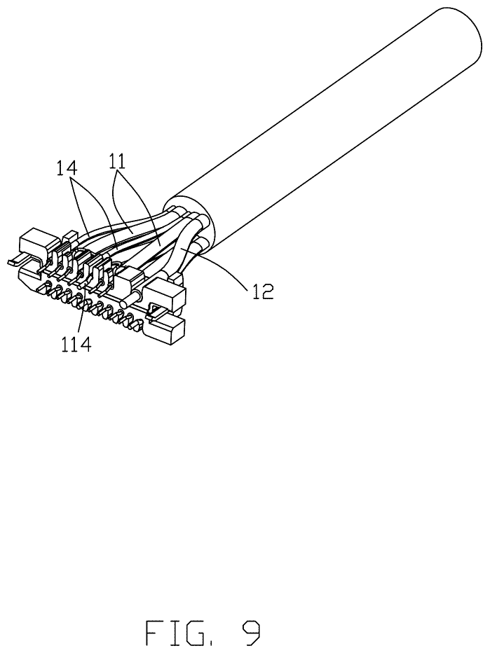

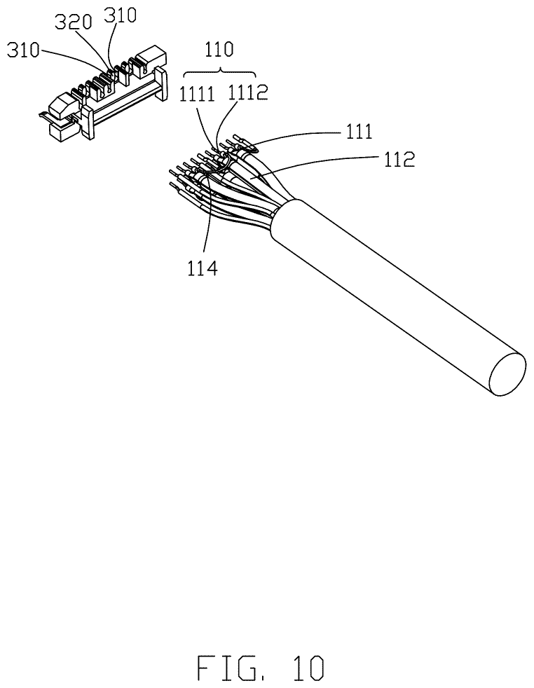

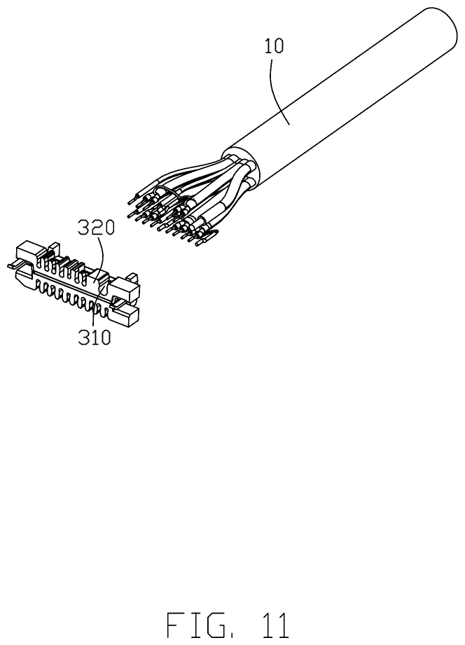

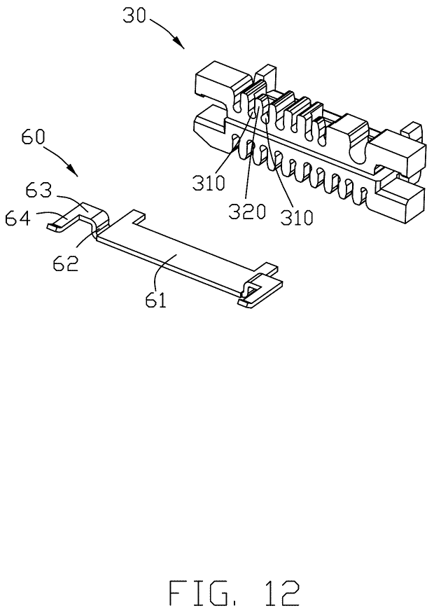

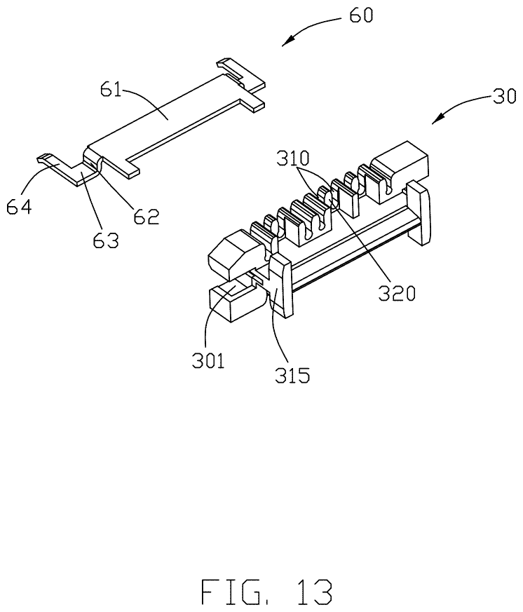

Referring to FIGS. 1-13, a cable connector assembly 100 in accordance with the present invention is shown. The cable connector assembly 100 comprises a cable 10 having a plurality of core wires, a wire clamp 30 disposed at the front of the cable 10, and an electrical connector 50 connected to the rear of the cable 10 opposite to the front. The wire are divided into two rows, upper and lower, and fixed to the wire clamp 30. The front end of each wire of the cable 10 extends forward beyond the wire clamp 30 so as to be directly connected to the mainboard 200 in the device. The mainboard 200 has an opening 201. The wire clamp 30 is received in the opening 201. Both sides of the mainboard 200 are provided with a row of conductive pads 210 arranged in a transverse direction.

The plurality of wires of the cable 10 are connected to corresponding conductive pads 210 of the mainboard 200. The wire clamp 30 is made of insulative material. The wire clamp 30 has a plurality of wire grooves 310 on both the upper and lower sides. The wire clamp 30 has a groove 301 on each lateral sides, and an abutment portions 315 located at rear of each of the grooves 301. The grooves 301 are used to receive the two sides of the opening 201 of the mainboard 200. The two sides of the opening 201 of the main board abut against the abutment portions 315. The plurality of wire grooves 310 on each side are arranged at intervals along the transverse direction. The wire grooves 310 correspond one-to-one to the wires connected to the mainboard 200. Two adjacent wire grooves 310 are separated by partition walls 320. The wires are received in the corresponding wire grooves 310. In this way, the wires are arranged at the wire clamp 30 in two rows spaced apart in the vertical direction. The rows of wires are arranged at intervals in the transverse direction. The size of the wire grooves 310 matches the outer diameter of the corresponding wires. The wire grooves 310 is used to sort out and position the wires so that the wires are arranged in order. The cross-sectional shape of each wire groove 310 is “Q” shaped, with the opening facing outward. Since the opening of the wire groove 310 is smaller, the wire is fixed in the corresponding wire groove 310 and is not easy to escape from the wire groove 310.

The cable connector assembly 100 further includes a glue block 40 formed by glue applied to the wire and the wire clamp 30. The glue block 40 fixes the wires and the wire clamp 30 together to facilitate soldering the wires to the conductive pads 210. The glue does not exceed the upper and lower surfaces of the wire clamp 30. The soldering joints between the wires and the conductive pads 210 are also filled with glue. The glue is UV glue. The dielectric constant Dk of the glue on the wire clamp 30 is 3.5. The dielectric constant Dk of the glue at the soldering joint is 5.0. By using UV glue with different Dk values at different locations, the attenuation can reach 0.34 dB.

The cable 10 includes a plurality of high-speed wire 11 for transmitting high-speed signals, a power wire 12 (VBUS) for transmitting power, a pair of low-speed signal wires 13(D+D−) for transmitting USB2.0 signals, two auxiliary signal wires 14 (SUB1, SUB2) for transmitting audio signals, etc. as needed, a chip power supply wire 15 (VCONN) used to supply power to the chip on the mother board 200, and a detection signal wire 16 (CC) used to determine the working status.

In the present invention, there are four high-speed wires 11 for transmitting four pairs of high-speed differential signals. Two high-speed wires 11 are respectively arranged in the upper row and the lower row. Each of the high-speed wire 11 includes a pair of core wires 110, a common shielding layer 111 covering the pair of core wires 110, an outer layer 313 covering the shielding layer 111, and a ground wire 114 disposed adjacent to the shielding layer 111. Each of the core wires 110 includes a inner conductors 1111 and an inner insulative layer 1112 covering the inner conductors 1111. The pair of core wires 110 are received in two adjacent wire grooves 310. The partition wall 320 between the two wire grooves 310 for receiving a pair of core wires 110 extending backward shorter than that of other partition walls 320. The common shielding layer 111 is located at rear side of the middle partition wall 320. The ground wires 114 of the two high-speed wires 11 on the same side are received in a same wire groove 310 located between the two high-speed wires 11, and extend forward out of the wire groove 310.

The cable connector assembly 100 further includes a shielding sheet 60 disposed on the wire clamp 30. The shielding sheet 60 is used to isolate the upper and lower rows of wires. The shielding sheet 60 electrically separates the exposed common shielding layer 111 of the upper and lower rows of high-speed wires 11. This design can make the impedance of the soldering point of a pair of high-speed wires 11 reach 86 ohms. The shielding sheet 60 is assembled on the wire clamp 30, or the shielding sheet 60 and the wire clamp 30 are integrally formed. The shielding sheet 60 includes a main body portion 61 extending in a transverse direction, a vertical portion 62 extending upward from front areas on each lateral sides of the main body portion 61, a horizontal portion 63 extending laterally from the vertical portion 62, and a soldering portion 64 extending forward from the horizontal portion 63. The lower surface of the horizontal portion 63 is in contact with the upper surface of the mainboard 200. The outer side of the vertical portion 62 is in contact with the two sides of the opening 201 of the mainboard 200. The soldering portion 64 is located on the outside of the cable 10. The shielding sheet shields the high-speed wires 11 on the upper and lower sides to prevent signal crosstalk. Furthermore, the mainboard is provided with a plurality of through holes (not shown) on the front and rear sides and the periphery of the conductive pads. The through holes are connected to grounding layers of the mainboard for grounding. In the present invention, by adding a shielding sheet 60 to the wire clamp 30, the crosstalk between high-speed wires is reduced to 3.21 dB.

On the upper surface of the mainboard, one auxiliary signal wire 14 is arranged between the two high-speed wire 11, the ground wires 114 of the two high-speed wires 11 is arranged between the pair of high-speed wires 11 and adjacent to the one auxiliary signal wire 14, another auxiliary signal wire 14 is located on the outside in the lateral direction and is arranged on opposite sides of the one high-speed wires 11 with the one auxiliary signal wire 14, and the power wire 12 is arranged on the outside of the other high-speed wire 11. Therefore, the wire on the upper side of the wire clamp 30 are arranged laterally as VBUS, TX2+, TX2−, GND of the two of high-speed wire 11, SBU1, TX1+, TX1−, SBU2. Correspondingly, the arrangement order of the conductive pads 210 corresponds to the wires of the cable 10.

On the lower surface of the mainboard, the chip power supply wire 15 is located between the two high-speed wires 11, the detection signal wire 16 is located on the outside of the pair of high-speed wire 11, and the detection signal wire 16 and the chip power supply wire 15 are arranged on opposite sides of a high-speed wire 11. the ground wires 114 of the two high-speed wires 11 are arranged between the pair of high-speed wires 11 and adjacent to the chip power supply wire 15, one of the low-speed signal wires 13 is arranged on the side of the other high-speed wire 11 opposite to the ground wire 114, the low-speed signal wire 13 includes a pair of low-speed core wires 131 and a ground wire 134, and the ground wire 134 is soldered to a conductive pad 210 located on the outside of the pair of low-speed core wires 131. Therefore, on the lower side 202 of the wire clamp 30, the wires are arranged laterally as GND, D+D−, TX2+, TX2−, GND of the two high-speed wires 11, VCONN, RX1−, RX1+, CC. Correspondingly, the arrangement order of the conductive pads 210 is consistent with that on the wires. The CC on the lower side is symmetrical with the SBU2 on the upper side in the vertical direction. The two high-speed wires 11 on the upper side and the two high-speed wires 11 on the lower side are symmetrically arranged in the vertical direction.

In the present invention, the wires 10 of cable are divided into two rows, upper and lower, and fixed to the corresponding upper and lower sides of the wire clamp 30, the front ends of each of the wires extend forward beyond the wire clamp 30 to be directly connected to the mainboard 200 in the device, and the shielding sheet 60 shields the two rows of wires, thereby achieving higher speed signal transmission.

1. A cable assembly comprising:
a cable having a plurality of wires;
a wire clamp disposed at a front of the cable; and
a shielding sheet fixed to the wire clamp; wherein
the plurality of wires are divided into an upper row and a lower row and fixed to the wire clamp, front ends of the plurality wires extend forward beyond the wire clamp to be directly connected to a mainboard, and the shielding sheet isolates the upper row of wires from the lower row of wires.

2. The cable assembly as claimed in claim 1, wherein the shielding sheet is assembled with the wire clamp.

3. The cable assembly as claimed in claim 1, wherein the wire clamp is integrally formed with the shielding sheet via insert molding.

4. The cable assembly as claimed in claim 1, wherein the wire clamp is made of insulative material.

5. The cable assembly as claimed in claim 1, wherein the wire clamp is provided with a plurality of wire grooves spaced apart in a transverse direction on both the upper and lower sides, and the plurality of wires are received in the corresponding wire grooves.

6. The cable assembly as claimed in claim 5, wherein the size of the wire grooves matches the outer diameter of the corresponding wires.

7. The cable assembly as claimed in claim 5, wherein the cross-sectional shape of each wire groove is “Q” shaped, with the opening facing outward.

8. The cable assembly as claimed in claim 5, wherein each of the upper row and lower row of wires includes a high-speed wire capable of transmitting a high-speed signal, and each of the high-speed wires includes a pair of core wires, a common shielding layer covering the pair of core wires, an outer layer covering the shielding layer, and a ground wire arranged in contact with the shielding layer.

9. The cable assembly as claimed in claim 8, wherein the pair of core wires of each high-speed signal are received in two adjacent wire grooves.

10. The cable assembly as claimed in claim 9, wherein two adjacent wire grooves are separated by a partition wall and the partition wall between the two wire grooves for receiving a pair of core wires extends backward a shorter distance than that of other partition walls.

11. The cable assembly as claimed in claim 8, wherein there are two high-speed wires in each of the upper row and lower row of wires, and the ground wires of the two high-speed wires on a row are received in a same wire groove located between the two high-speed wires.

12. The cable assembly as claimed in claim 8, wherein the plurality of wires comprise a power wire (VBUS), a pair of low-speed signal wires (D+D−), two auxiliary signal wires (SUB1, SUB2), a chip power supply wire (VCONN), and a detection signal wire (CC).

13. The cable assembly as claimed in claim 1, further comprising a glue block formed by glue applied on the wires and the wire clamp, wherein the glue block fixes the wires to the wire clamp.

14. The cable assembly as claimed in claim 13, wherein a soldering joint between the wire and a conductive pad on the mainboard is filled with glue.

15. The cable assembly as claimed in claim 14, wherein the dielectric constant of the glue on the wire clamp is 3.5, and the dielectric constant of the glue at the soldering joint is 5.0.

16. The cable assembly as claimed in claim 3, wherein the wire clamp is to be received in an opening of the mainboard, and the wire clamp has a groove at each side in a transverse direction and an abutment portion located at a rear of each groove.

17. The cable assembly as claimed in claim 16, wherein the shielding sheet includes a main body portion extending in a transverse direction, a vertical portion extending upward from the front area on each transverse side of the main body portion, a horizontal portion extending laterally from the vertical portion, and a soldering portion extending forward from the horizontal portion.

18. The cable assembly as claimed in claim 17, wherein the outer side of the vertical portion is in contact with the side of the opening on the mainboard, and the lower side of the horizontal portion is in contact with the upper surface of the mainboard.

19. A cable connector assembly comprising:
a cable having a plurality of wires;
a wire clamp disposed at a front of the cable;
an electrical connector connected to a rear end of the cable; and
a shielding sheet fixed to the wire clamp; wherein
the plurality of wires are divided into an upper row and a lower row at the front and fixed to the wire clamp, each row of the wires comprising a high-speed wire capable of transmitting differential high-speed signals, front ends of the plurality of wires extend forward beyond the wire clamp to be directly connected to a mainboard, and the shielding sheet isolates the upper row of wires from the lower row of wires.

20. The cable connector assembly as claimed in claim 19, wherein the wire clamp is made of insulative material and is integrally formed with the shielding sheet via insert molding, and the wire clamp is provided with a plurality of wire grooves for receiving corresponding wires.
